(19) United States
(12) Patent Application Publication
(10) Pub. No.: US 2004/0222711 A1
(43) Pub. Date: Nov. 11, 2004

(54) Dynamoelectric machine

(76) Inventor: Michael Klimt, Kirchdorf (DE)

Correspondence Address: DILWORTH & BARRESE, LLP, 333 EARLE OVINGTON BLVD., UNIONDALE, NY, 11553, US

(21) Appl. No.: 10/779,491

(22) Filed: Feb. 13, 2004

(30) Foreign Application Priority Data
Feb. 13, 2003 (DE) 103 06 071.5
May 27, 2003 (DE) 103 24 089.6

(51) Int. Cl. H02K 9/00; H02K 1/32

(52) U.S. Cl. 310/59; 310/64

(57) ABSTRACT

A dynamoelectric machine with a closed interior cooling circuit comprises a heat exchanger within a heat exchanger housing. In order to improve a dynamoelectric machine of this type, the heat exchanger is designed in the form of a plate heat exchanger having exchanger plates (6). The exchanger plates (6) are separated from one another by spacers (7) which have been incorporated on one or both sides of the exchanger plates (6) by a stamping process, specifically, by deep-drawing (FIG. 5).

The invention relates to a dynamoelectric machine with a closed interior cooling circuit and heat exchanger within a heat exchanger housing. The dynamoelectric machine may be operated either as a motor or as a generator.

Dynamoelectric machines, such as electric motors and generators, are generally provided with a cooling circuit of appropriate design to remove the excess heat generated within the machine. A survey of possible types of cooling for dynamoelectric machines is found, for example, in IEC 34-6.

With electrical machines of higher output, interior cooling of the machine is generally implemented so as to improve the removal of heat from the interior of the machine. In this case, a cooling medium (with gas-cooled machines, for example, air or another cooling gas; with liquid-cooled machines, a liquid such as oil, aqueous solution or other liquid) flows in an axial direction through the air gap between rotor and stator, and, if necessary, through axial cooling holes in the rotor, or through axial cooling holes in the stator. At the same time, cooling may be improved by additional radial cooling slots provided in the rotor and/or stator.

In closed machines (such as protection class IP 44 or better), the cooling circuit is in the form of a closed internal cooling circuit with an additional heat exchanger to dissipate the heat to an external cooling medium. The internal cooling here may use a single-pass or a double-pass design.

Today, tube-type coolers are generally employed as top-mounted coolers for air/air-cooled (or more generally gas/gas-cooled) motors or generators having top-mounted coolers.

Dynamoelectric machines according to the preamble of claim 1 are known technology. Also known is the principle whereby the dynamoelectric machine has an attached or top-mounted cooler. These attached or top-mounted coolers generally involve air-air heat exchangers or air-liquid heat exchangers.

In the prior art, the attached or top-mounted air-liquid heat exchangers are generally in the form of fin-type heat exchangers analogous to those known from the combustion engine design. Here the fluid medium flows through tubes, often metal tubes. The tubes support ribs or metal ribs along their periphery, or they pass through a system of ribs or fins composed of metal, by which system they effect a direct heat exchange, where the gaseous medium flows around the metal ribs. In a dynamoelectric machine, the heat energy is withdrawn by the heat exchanger through the closed interior circulation circuit as the primary cooling circuit. The fluid medium flowing through the heat exchanger is moved as the secondary cooling medium in an open system or in a closed circuit.

Attached or top-mounted air-air heat exchangers are thus designed as tube-type heat exchangers in the prior art. The heat exchanger tubes of the tube-type heat exchanger generally pass through the heat exchanger housing in an axial direction relative to the shaft of the dynamoelectric machine. They are attached in a form-fitting design to the end faces of the heat exchanger, for example, by a rolling-in process to the faces of the heat exchanger. As a result, the interior of the heat exchanger is delimited by the housing of the heat exchanger and the outer surface of the tubes. The interior cooling medium of the dynamoelectric machine, generally air, flows within the interior of the heat exchanger.

Plate heat exchangers are generally employed only in liquid-liquid heat exchangers.

Recuperative plate heat exchangers are known from the literature. They are constructed out of, preferably, identical exchanger plates between which successive, mutually separate flow paths extend for two medium flows effecting an indirect heat exchange. Two medium flows, effecting heat exchange through exchanger plates, flow through the resulting successive flow paths, preferably, in a cross-flow pattern.

Due to a variety of disadvantages, plate heat exchangers are not employed as air-air heat exchangers in dynamoelectric machines.

The known and conventional plate heat exchangers are thus complex in terms of their mechanical design, are expensive due to their generally multilayer design employing smooth plates as the separative elements and additional structured plates as spacers, and are not optimal in terms of the efficiency of the heat transfer.

In the case of air-air heat exchangers (or more generally, gas/gas heat exchangers), plate heat exchangers are not commonly found due to the low heat transfer coefficients and the resulting large heat exchanger surface required, the resulting large heat exchangers thus having a correspondingly high own weight. Another reason here is the complicated design and frequent susceptibility to breakdown on the part of these coolers.

A number of different designs for plate heat exchangers are known from the literature. For example DE-GM 84 17 650 discloses a recuperative plate heat exchanger composed of exchanger plates which are held by spacers at mutual intervals. Successive flow paths for two medium flows passing through the heat exchanger in a cross-flow pattern and effecting an indirect heat exchange extend between the exchanger plates. The plate heat exchanger has a multilayer design composed of smooth plates as the separative elements and additional structured plates as the spacers. The spacers may be rigidly attached to one exchanger plate each. They extend at least up to directly against the adjacent exchanger plate. The spacers may be in the form of links or material strips which meander in-between the exchanger plates, or in the form of a corrugated section. However, these heat exchangers based on the prior publication are expensive, heavy, and not of optimal efficiency in terms of heat transfer.

Additional design embodiments and improvements for plate heat exchangers have been disclosed in publications DE 34 15 733 A1, DE 100 34 343 C2, EP 0 851 199 A2, and EP 1 022 533 A1.

In these embodiments as well, the use of a plate heat exchanger in the form of an air-air heat exchanger for dynamoelectric machines is not technically feasible due to the complicated air circulation within the interior cooling circuit, and due to the resulting problems related to obtaining a uniform air flow within different regions of the cooler. The additional high cost and technical complexity required to seal the cooler so as to attain the corresponding mechanical and electrical protection class of IP 44 or better make the use of these coolers for dynamoelectric machines impractical.

The result of the problems referenced above is that tube-bundle coolers (heat exchangers) have been the standard in actual use up to the present time.

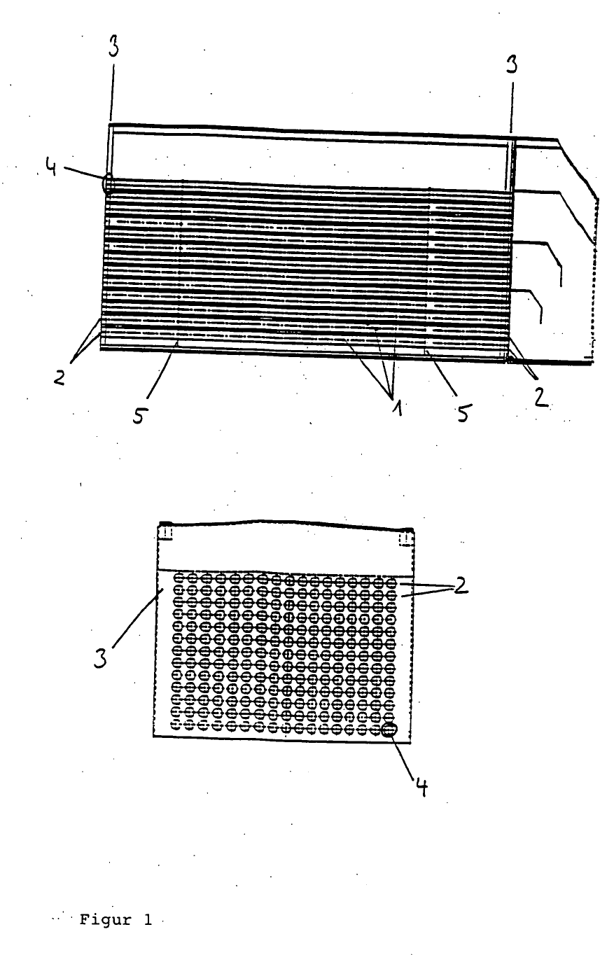

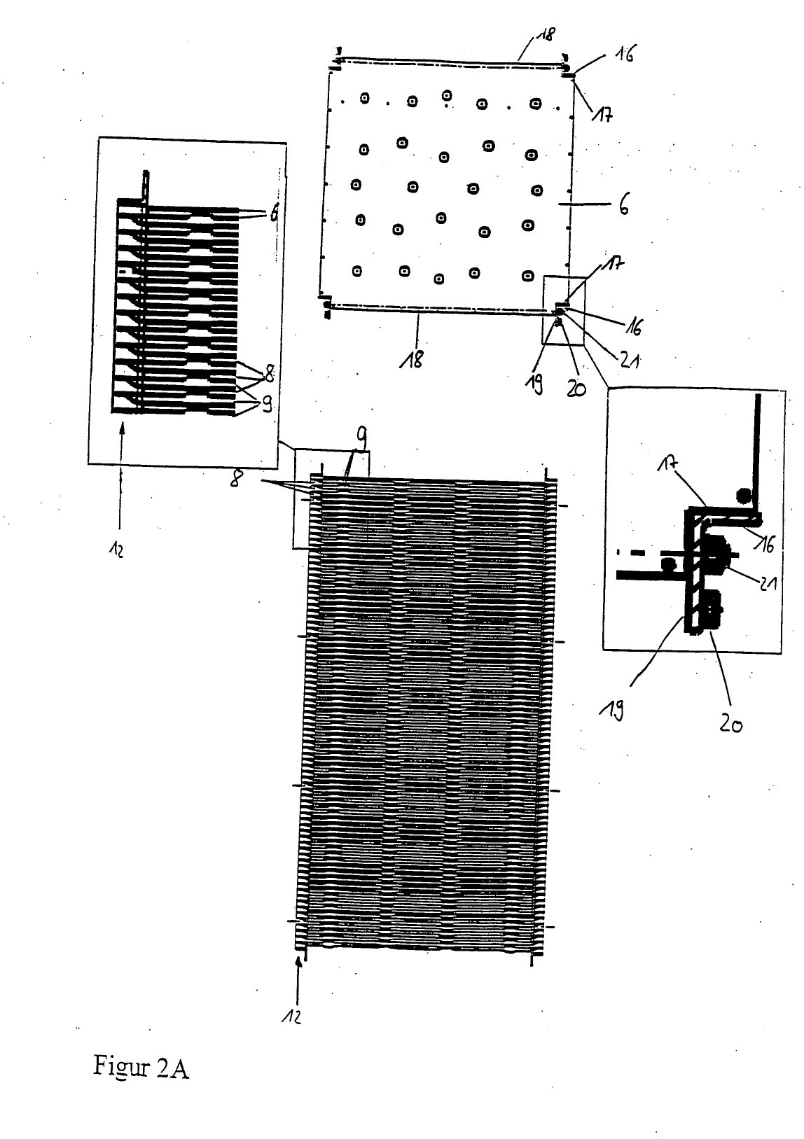

FIG. 1 provides a side view (top) and front view (bottom) of an example of a tube-bundle cooler (heat exchanger) of this type for a dynamoelectric machine. Cooling tubes 1 are held in cylindrical holes 2 in the end faces 3 of the cooler, and appropriately sealed at sealing locations 4 relative to the cooler interior. In some cases, partitions 5 are provided in the cooler to support cooling tubes 1 and for purposes of air conduction. The external cooling medium (e.g., air) flows through cooling tubes 1. In the cooler, the interior cooling medium of the dynamoelectric machine flows around individual cooling tubes 1. The flow of cooling medium is conducted through the interior of the cooler by means of directional baffles and baffle plates. This cooler design too is quite complex and cost-intensive.

The object of the invention is therefore to improve a dynamoelectric machine of the type referenced in the introduction.

According to the invention, this object is achieved by the characterizing features of claim 1. The heat exchanger is in the form of a plate heat exchanger having exchanger plates. The exchanger plates are separated by spacers which have been incorporated in the exchanger plates on one or both sides by a stamping process, specifically, by deep-drawing. The exchanger plates, which are preferably identical, are held with a predefined spacing relative to each other by spacers molded on using this technique.

Advantageous modifications are described in the subclaims.

The plate heat exchanger is preferably in the form of a gas-gas heat exchanger, specifically, an air-air heat exchanger. This is preferably in the form of a so-called recuperative plate heat exchanger.

It is advantageous if the flow path for the secondary cooling medium flow runs parallel to the rotor of the dynamoelectric machine. In other words, the flow path for the secondary cooling medium runs preferably in the axial direction relative to the dynamoelectric machine.

The flow paths for the medium flows within the plate heat exchanger are preferably routed in a cross-current pattern. When the flow path for the secondary cooling medium flow runs parallel to the rotor of the dynamoelectric machine, the flow path for the primary medium flow preferably runs radially relative to the dynamoelectric machine.

It is advantageous if the plate heat exchanger is composed of multiple modules. The modules may be of identical design. They may, however, also differ from one another. The flow paths for the medium flows are preferably routed within each individual module in a cross-flow pattern.

Another advantageous embodiment is characterized in that the modules are adjacent to one another in a direction parallel to the rotor of the dynamoelectric machine. The flow path for the secondary cooling medium runs preferably parallel to the rotor of the dynamoelectric machine—in particular, preferably through the entire heat exchanger, that is, through all modules. It is advantageous if the flow paths for the primary medium flow run through the modules radially relative to the rotor of the dynamoelectric machine. The flow paths for the primary medium flow through the modules are preferably separated from one another.

By using a corresponding design for the plate heat exchanger, multiple mutually separated sections may be created in the cooling circuit interior in the axial direction of the dynamoelectric machine, through which sections the interior cooling medium (primary medium) of the electric machine flows in different directions, while cooling channels for the external medium (secondary medium) which pass through the entire heat exchanger are created in the axial direction.

In another advantageous embodiment, air guides are provided between the stator of the dynamoelectric machine and the plate heat exchanger. The use of these additional air guides between the dynamoelectric machine and the attached heat exchanger or top-mounted heat exchanger enables a uniform air-entry to be obtained into the plate heat exchanger, specifically, in a direction perpendicular to the rotor (that is, in a radial direction perpendicular to the rotational axis of the rotor).

Additional advantageous modifications are described in the subsequent subclaims.

Embodiments of the invention are described below in detail based on the attached drawings.

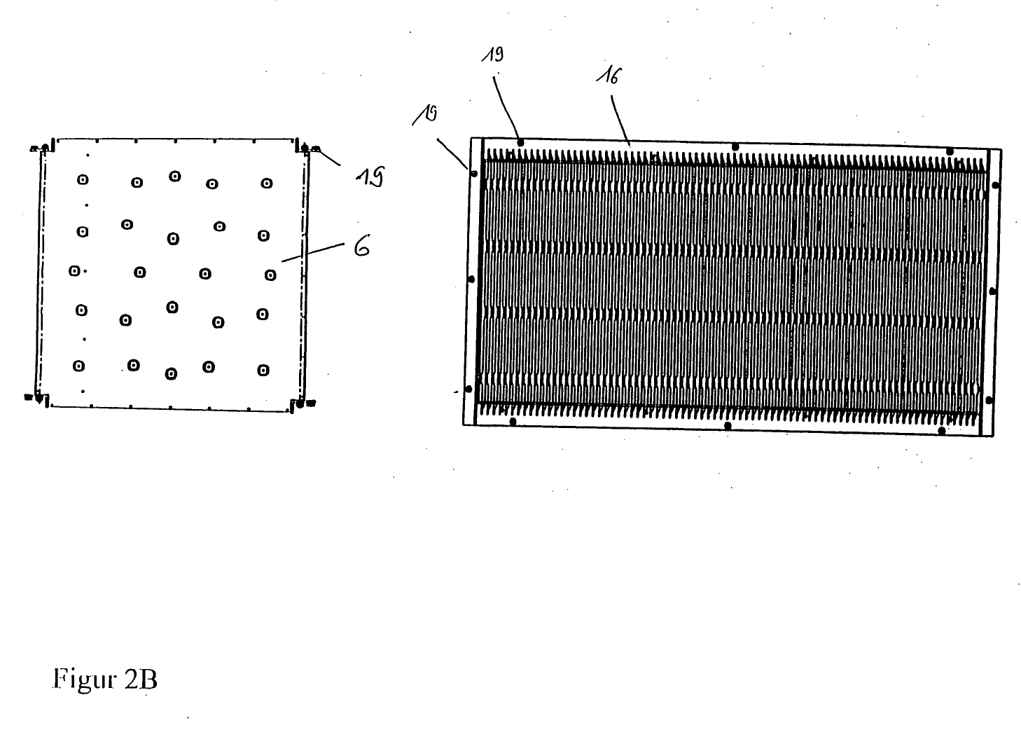

FIGS. 2A and 2B provide a schematic diagram of a plate heat exchanger according to the invention having a quadratic base design, shown in a front view (top), in a side view (bottom), and in two enlarged partial views, as well as (FIG. 2b) in a front view (left) and side view (right);

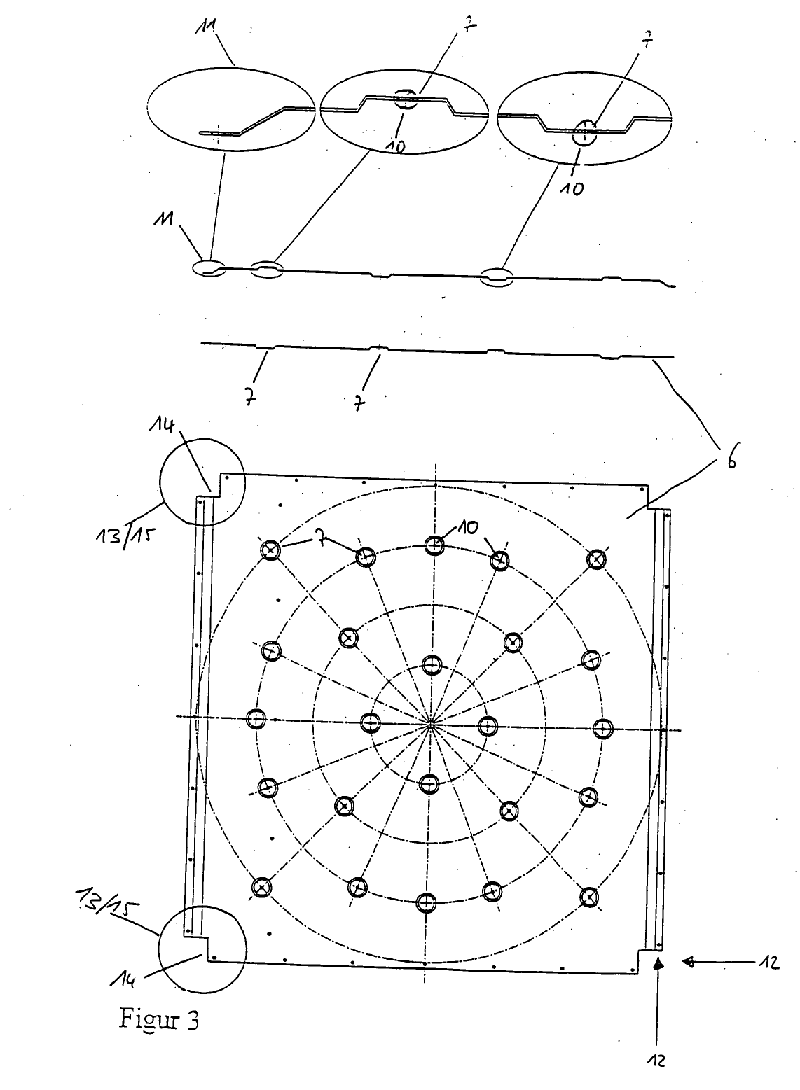

FIG. 3 shows a quadratic heat exchanger plate as the basic module for constructing the plate heat exchanger shown in FIG. 2, in a front view (bottom) and side view (top), portions of which are enlarged;

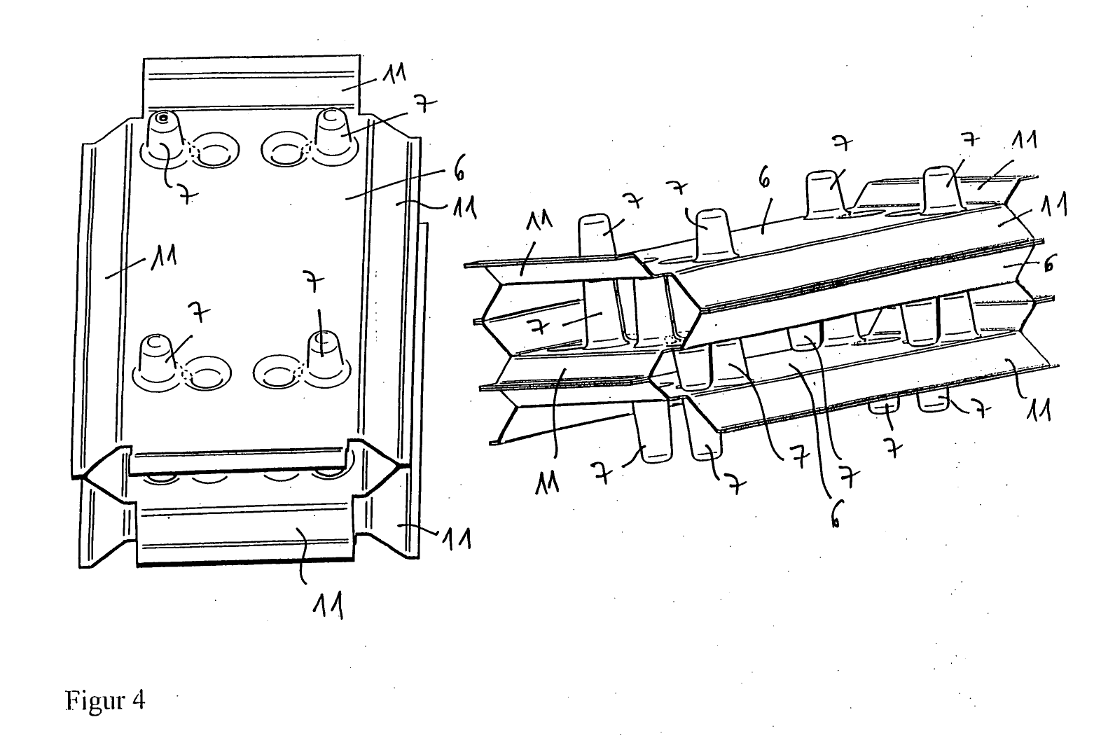

FIG. 4 provides a schematic diagram of a plate heat exchanger according to the invention having a rectangular basic design, shown in two perspective views;

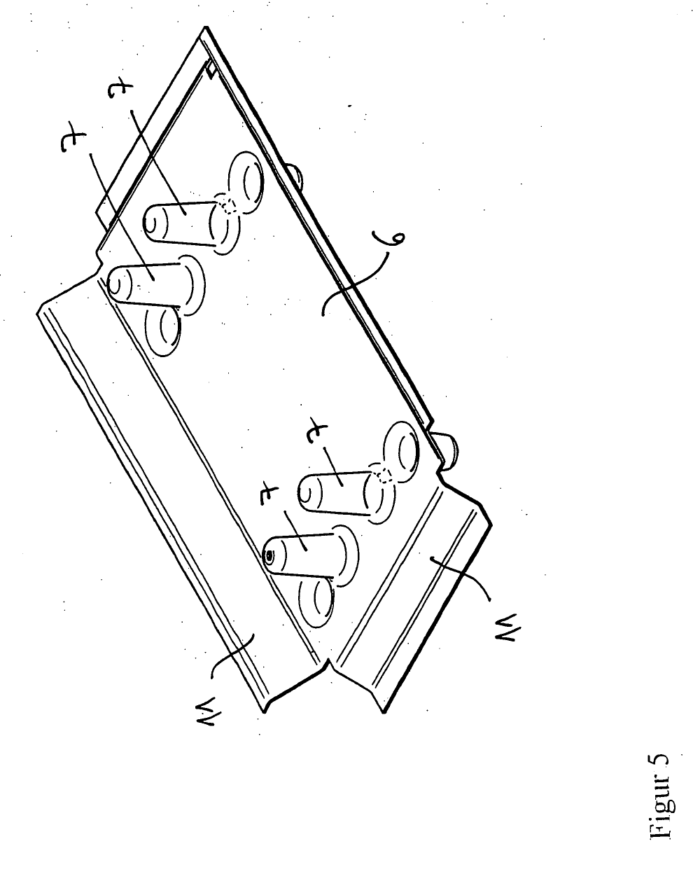

FIG. 5 shows a rectangular heat exchanger plate as the basic module for constructing the plate heat exchanger shown in FIG. 4, in a perspective view;

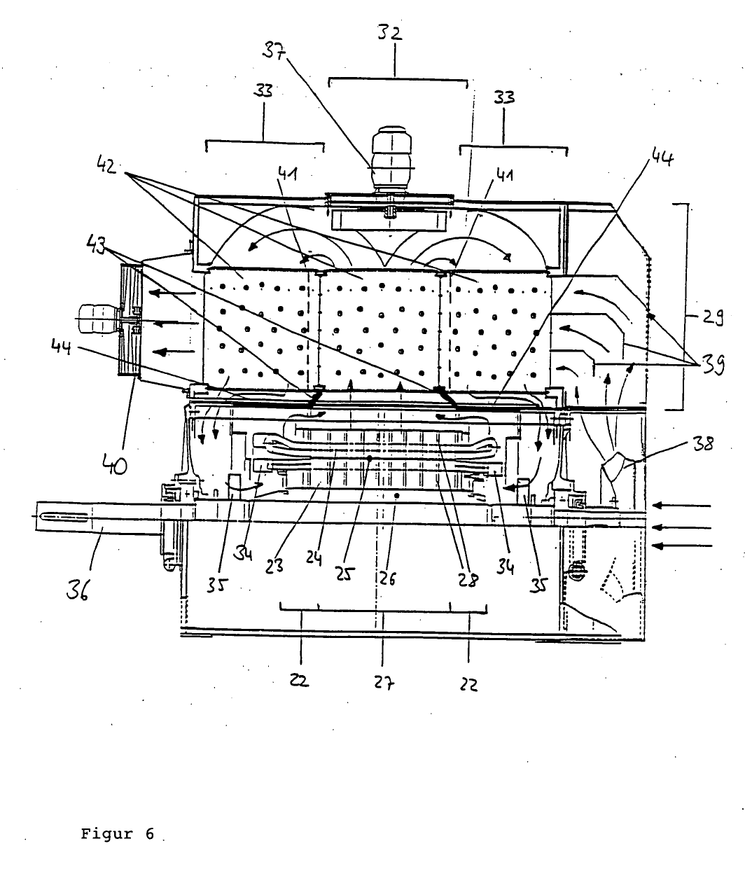

FIG. 6 shows a dynamoelectric machine having a double-pass interior cooling circuit and top-mounted gas/gas plate heat exchanger; and

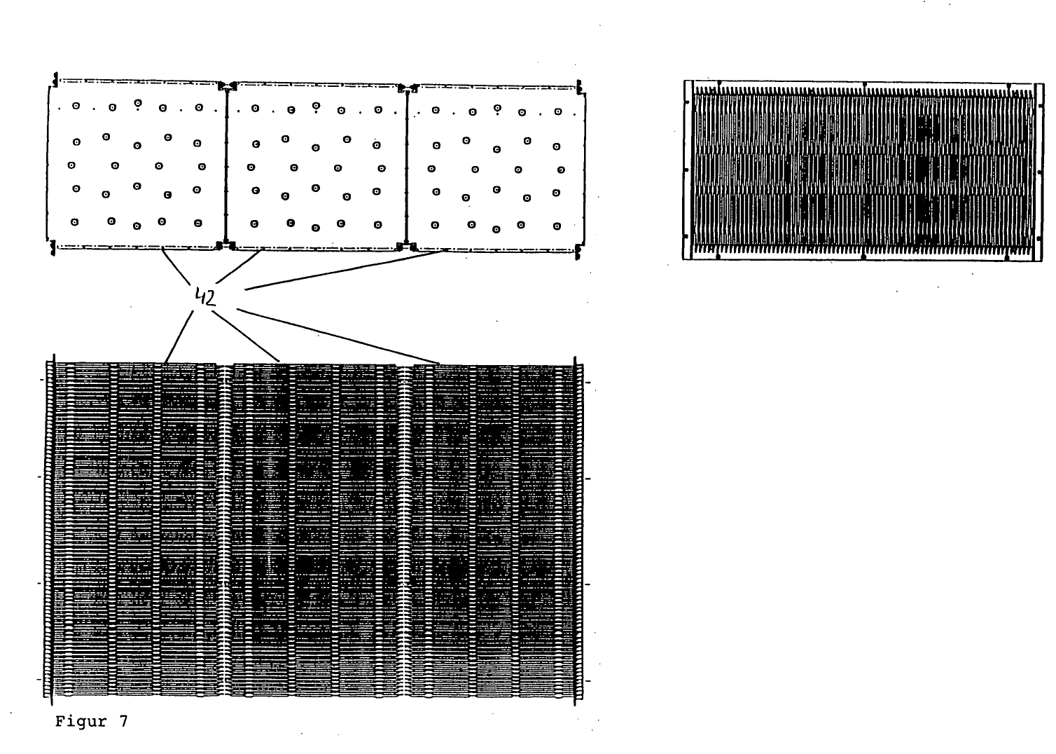

FIG. 7 shows the plate heat exchanger implemented in a modular design, in a front view and two side views.

FIGS. 2A and 2B provide a schematic diagram of a plate heat exchanger according to the invention based on the embodiment features of the invention. Related to this, FIG. 3 shows an individual exchanger plate 6 designed as a heat exchanger plate with a square contour in which spacers 7 have been incorporated by a stamping process, specifically, by deep-drawing. The recuperative plate heat exchanger encloses exchanger plates 6 which are separated by spacers 7.

An advantageous principle of the invention consists in constructing the recuperative plate heat exchanger out of individual plates which form exchanger plates 6, while integrating the respective spacers 7 in the individual exchanger plates by deep-drawing or an analogous stamping process. This concept eliminates the need for the additional spacers (corrugated sheets) required by prior-art proposals such as that in DE-GM 84 17 650. A variety of different sheet metal types may be employed here, such as black sheet, galvanized sheet, or sheet metal composed of stainless steel. According to the invention, these spacers 7 impressed on one or both sides into the base material of individual exchanger plates 6.

Individual exchanger plates 6 are stacked, separated by impressed spacers 7, so as to produce between two successive exchanger plates 6 separated flow paths 8, 9 for two cooling medium flows conducted through the heat exchanger in a cross-flow pattern. The space between individual exchanger plates 6 is defined here by cambering the stamped sections for spacers 7, and, as required, by abutting stamped sections 7 of successive exchanger plates 6.

The mechanical connection between the individual exchanger plates 6 of the recuperative plate heat exchanger is advantageously implemented by locally joining individual exchanger plates 6 at the sites of spacers 7 (e.g., by a welding process such as spot welding, soldering, stamping, adhesive bonding, or riveting). In the event riveting is employed, it is advantageous according to the invention in terms of the cost-effective fabrication of the plate heat exchanger to punch the corresponding holes 10 for insertion of the rivets already at the stage of stamping the spacers. An analogous approach applies to any holes in the plates that form exchanger plates 6, which holes may be required for the spot welding or local welding of the plates. Preferably, when riveting is used, a form-fitting seal between individual exchanger plates 6 at the riveting sites (at the passage for the rivets through the exchanger plates) is obtained at the same time that individual exchanger plates 6 are joined. The rivets used may be blind rivets or cup-type rivets. If a welding process is used for mechanical joining, according to the invention no leaks may be present at the welds allowing any exchange of cooling medium beyond the plate limit.

One problem related to the design of the invention is the sealing of individual flow channels in the peripheral regions of exchanger plates 6. In an advantageous embodiment of the invention, the seal is implemented for the individual cooling channels 8, 9 of the plate heat exchanger in the peripheral regions of exchanger plates 6 by providing the peripheral regions of individual exchanger plates 6 with corresponding folds 11, ideally, at an angle between 15° and 60°, which are arranged and dimensioned such that individual exchanger plates 6 just touch or very closely approach each other based on the space created by the arrangement of spacers 7 between individual exchanger plates 6 in peripheral regions 12 which must be sealed during the stacking process of assembly. In a cost-optimized fabrication process for the plate heat exchanger, these folds 11 are fabricated along with the stamping of spacers 7 in one operational procedure. The joining and/or sealing of individual exchanger plates 6 in these peripheral regions 12 is preferably implemented by flanging, welding, adhesive bonding, or soldering/brazing. As an additional measure in all cases, an additional riveting may be effected which may function both as an assembly aid and, in the case of adhesive bonding, as an additional means of mechanical fixation. The adhesive compound here may also function simply as a sealing compound, the actual mechanical joint being created by the riveting.

An additional problem related to sealing the individual crossed flow paths in a plate heat exchanger according to the invention is posed by the edges 13 at which the individual crossing flow directions meet. In an advantageous embodiment of the invention, special L-shaped notches 14 are provided at these edges which create L-shaped punch-outs 15 in the base plates of exchanger plates 6. In a cost-optimized fabrication method, these notches 14 are also punched out at the time spacers 7 are also stamped. L-shaped or U-shaped sheet-metal sections 16 with additional appropriate sealing strips 17 to effect sealing are incorporated in the resulting notches 14 at the edges of the heat exchanger, and these sections are attached by a frame construction (also adding mechanical stability to the heat exchanger unit) or by threaded rods 18 in the form of tension rods and self-locking nuts 21, and/or by specially provided retainers 19 and screws 20. Sealing strips 17 may be attached here in appropriately provided recesses.

The L-sections or U-sections 16, together with the tension rods 18, nuts 21, holders 19 and screws 20, may also in the form of a separate frame or supporting frame which provides mechanical stability to the heat exchanger unit, in particular, for transport and assembly within the heat exchanger housing.

In another advantageous embodiment of the invention, additional stamped areas to increase the surface (of the active heat exchanger surface), to improve or enhance turbulent air mixing within the plate heat exchanger, or to improve the passage of air in the plate heat exchanger may be incorporated—in addition to the spacers—in the base plates of individual exchanger plates 6. In one cost-effective embodiment variant, these stamped areas are incorporated in one operational procedure together with the stamped areas for the spacers.

Additional air fins may be incorporated into exchanger plates 6 or attached to them.

Additional approaches to optimizing the fabrication cost for a recuperative plate heat exchanger according to the invention are provided by a special topological design for exchanger plates 6 which enables the entire plate heat exchanger to be constructed by appropriately rotating the individual exchanger plates 6. With rectangular exchanger plates 6, rotation is possible by 180° about an axis perpendicular to the plate plane, as well as by 180° about an axis in the plate plane. In the case of square exchanger plates 6, the rotation is possible by 90° or 180° about an axis perpendicular to the plate plane, as well as by 180° about an axis in the plate plane.

FIG. 3 shows an example of a corresponding exchanger plate 6, while FIGS. 2A and 2B show the heat exchanger created by a corresponding combination of exchanger plates 6 rotated relative to one another. FIGS. 4 and 5 show an analogous example with a rectangular structure. By using an analogous design for stamped spacers 7, in both examples various additional plate separations may be realized for the two independent crossing cooling medium flows so as to optimize the heat exchanger according to the specified substance quantity flows and desired heat exchanger properties.

In another embodiment according to the invention, a plurality of such heat exchanger modules, such as those shown in FIG. 2 or FIG. 4, are combined by simply putting them together to form a larger heat exchanger, thereby adjusting the performance of the heat exchanger in a modular fashion to the corresponding requirements. As a result of the notches 14 explained above in the corners of individual exchanger plates 6, U-shaped recesses are created at the connection points between the individual heat exchanger modules, into which, in a manner analogous to the L-sections, matching U-shaped sections with appropriate sealing strips are now inserted, for example, ones composed of silicon microcellular rubber or similar materials, whereby these sections may be attached using a frame construction or holders or threaded rods in the form of tension rods. This creates both a seal for the individual modules at the corner as well as a mechanical connection for the individual modules.

The combination of a plurality of such modules of the type described to form one complete heat exchanger is especially advantageous for the design of the air circulation of the interior cooling circuit within the heat exchanger housing. It is especially advantageous here if the flow through the interior cooling circuit of the individual heat exchanger modules takes place from different directions offset by 180° relative to each other.

FIG. 6 shows a dynamoelectric machine with a closed interior cooling circuit and an attached gas-gas heat exchanger in a heat exchanger housing, wherein the heat exchanger is, unlike the normal conventional tube-bundle exchangers, in the form of a recuperative plate heat exchanger, and the cooling medium flow in the interior cooling circuit of the machine and external cooling medium flow effect an indirect heat exchange, and are passed in a cross-flow pattern between the successive flow paths which are mutually separated by the exchanger plates. The individual exchanger plates of the heat exchanger are separated by spacers which have been incorporated into the individual exchanger plates on one side or both sides by deep-drawing or similar stamping process before the mechanical construction of the heat exchanger module.

The special design for the recuperative heat exchanger may be implemented with the features described above.

It is especially advantageous to implement a design according to the invention for dynamoelectric machines in a so-called double-pass embodiment. FIG. 6 is a schematic view of the cooling circuit of dynamoelectric machines in a double-pass embodiment: The internal cooling medium flows from the peripheral regions 22 of the rotor laminated core 23 and of stator laminated core 24 through the air gap 25, and optional axial cooling channels 26, within the rotor and stator laminated core into the central regions 27 of the rotor and stator laminated core; then is passed here through radial cooling slots 28 in the stator, and possibly the rotor (in rotors with axial cooling holes in the rotor laminated core) into the cooler or heat exchanger 29. After a first passage through the central or mid region of plate heat exchanger 29, another passage through the outer or peripheral regions 33 of the plate heat exchanger takes place, along with a return of the cooling medium into the dynamoelectric machine. The internal cooling medium is driven by the radial fanning action of the rotating rotor laminated core 23, possibly including an additional appropriate design for the rotor to support the fanning action, e.g., by an attached fan blade 34, possibly supported by axial-flow fans 35 on rotor shaft 36, which push the cooling medium in the direction of the laminated core of the stator and rotor, and possibly supported by an additional fan arrangement 37 in the attached cooler (heat exchanger).

The external cooling medium flow is driven by a fan 38 which sits directly on main rotor shaft 36, the moved cooling medium, preferably, ambient air, being conducted through appropriate air guides 39 into the attached plate heat exchanger. As an alternative to the fan on the main rotor shaft, the external cooling medium flow may also be driven by a separate fan 40 which is attached to, or directly integrated into, the heat exchanger housing.

The air flow conduction for the interior medium described above is implemented by appropriate air guides 41 in the plate heat exchanger.

In the embodiment of the invention shown in FIG. 7, the plate heat exchanger for the dynamoelectric machine is constructed out of individual, specifically, three preferably design-identical modules 42 which are connected and sealed at their connection points—as already described above for the construction of the plate heat exchanger—by corresponding, for example, U-shaped and/or L-shaped sheet-metal sections with additional sealing strips inserted in the appropriately provided recesses of the individual modules. The individual modules of the plate heat exchanger are arranged here such that they implement in plate heat exchanger 41 an interior cooling circuit of a double-pass dynamoelectric machine with an attached plate heat exchanger of a double-pass design—possibly together with additional spacers and sealing elements 43 between the heat exchanger module and dynamoelectric machine, or directly between air guides 44 provided in the dynamoelectric machine—but without the requirement of the above-referenced additional air guides.

Unlike the prior-art design of a gas-gas cooler, specifically, for dynamoelectric machines in the form of tube-bundle coolers, the embodiment of the invention for a plate heat exchanger provides a variant which is distinguished by a simple design, with the resulting savings in fabrication cost.

At the same time, a favorable embodiment of the heat exchanger or of the heat exchanger module provides a savings in weight, and possibly also an advantage in terms of unit volume as compared with a conventional tube-bundle cooler.

As a result, use of the plate heat exchanger according to the invention becomes competitive with air-air cooling, even in terms of its use in dynamoelectric machines of the enclosed type.

The construction of the plate heat exchanger from individual exchanger plates of the same type provides simple up-scalability for the heat exchanger or heat exchanger module. The modular construction of the heat exchanger from individual heat exchanger modules additionally provides for a very high level of design variability using the few basic elements (ideally, a single type of exchanger plate). The construction of the heat exchanger from individual modules, according to the design features described, provides heat exchanger segments in the axial direction of the dynamoelectric machine which are advantageous in terms of the interior cooling circuit, are separated from each other—thus allowing the flow in opposite directions through the heat exchanger segments—without the requirement of additional complex and expensive air guides in the interior of the heat exchanger modules.

As is evident in the description of the preferred embodiments, it is possible to realize a recuperative plate heat exchanger which is optimized in terms of technical complexity, use of materials, fabrication cost, as well as the efficiency of the heat exchange. In the case of a dynamoelectric machine, it is possible to employ a recuperative plate heat exchanger of the type described in place of a conventional top-mounted cooler. FIG. 1 is a schematic view of a conventional tube-bundle cooler for a dynamoelectric machine, such as those used in the form of attached coolers, for example, air/air-cooled machines of closed design.

Based on their design features, both in terms of fabrication costs and complexity, as well as in regard to own weight, volume and cooling performance, the plate heat exchangers described in the embodiments provide an improvement over tube-bundle coolers previously employed in dynamoelectric machines.

1. Dynamoelectric machine with a closed interior cooling circuit and heat exchanger within a heat exchanger housing,
the heat exchanger being in the form of a plate heat exchanger (6),
wherein the exchanger plates (6) are mutually separated by spacers (7) which have been incorporated on one or both sides into the exchanger plates (6) by a stamping process, specifically, by deep-drawing.

2. Dynamoelectric machine according to claim 1, characterized in that the plate heat exchanger is a gas-gas heat exchanger, specifically, an air-air heat exchanger.

3. Dynamoelectric machine according to claim 1, characterized in that the flow path for the secondary cooling medium flow runs parallel to the rotor of the dynamoelectric machine.

4. Dynamoelectric machine according to claim 1, characterized in that the flow paths for the medium flows are conducted in a cross-flow pattern within the heat exchanger.

5. Dynamoelectric machine according to claim 1, characterized in that the plate heat exchanger is composed of a plurality of modules (42).

6. Dynamoelectric machine according to claim 5, characterized in that the modules (42) are arranged adjacent to one another in a direction parallel to the rotor of the dynamoelectric machine.

7. Dynamoelectric machine according to claim 6, characterized in that the flow paths for the primary medium flow through the modules (42) run radially relative to the rotor of the dynamoelectric machine.

8. Dynamoelectric machine according to claim 6, characterized in that the flow paths for the primary medium flow through the modules (42) are separated from one another.

9. Dynamoelectric machine according to claim 1, characterized in that air guides are provided between the stator of the dynamoelectric machine and the plate heat exchanger.

10. Dynamoelectric machine according to claim 1, characterized in that the dynamoelectric machine is a machine having a double-pass interior cooling circuit, wherein the cooling medium flows out of the dynamoelectric machine and through the heat exchanger in the center region (32) of the plate heat exchanger (29), is then diverted in an adjacent space within the heat exchanger housing, and flows back again into the dynamoelectric machine through peripheral regions (33) of the heat exchanger.

11. Dynamoelectric machine according to claim 1, characterized by a fan impeller (38) located directly on the shaft (36) of the dynamoelectric machine, or by a separate fan (40).

12. Dynamoelectric machine according to claim 1, characterized in that the exchanger plates (6) are connected to each other at the contact points of the spacers (7) by spot welding, adhesive bonding, riveting, or soldering/brazing.

13. Dynamoelectric machine according to claim 1, characterized in that in addition to the stamped sections for the spacers (7), additional stamped sections are incorporated so as to increase the active heat exchanger surface and/or to increase turbulent air mixing.

14. Dynamoelectric machine according to claim 1, characterized in that additional air fins are incorporated into the individual exchanger plates, or are attached to these plates.

15. Dynamoelectric machine according to claim 1, characterized in that the exchanger plates (6) are designed so that the connection points for the exchanger plates (6) are able to be aligned relative to each other by rotating the individual exchanger plates (6) by 90° or 180° about an axis perpendicular to the plate plane, and/or by rotating them by 180° about an axis in the plate plane.

16. Dynamoelectric machine according to claim 1, characterized in that the outer edges of the exchanger plates (6) have folds (11) with an angle of preferably between 15° and 60° which due to the spacing of the stamped spacers (7) touch each other when the exchanger plates (6) are stacked.

17. Dynamoelectric machine according to claim 16, characterized in that the exchanger plates (6) are connected at the folds (11) by flanging or welding or riveting or adhesive bonding.

18. Dynamoelectric machine according to claim 1, characterized in that the modules (42) are connected and sealed at their outer edges or connecting edges by L-shaped or U-shaped sheet-metal sections (16) having sealing strips (17) which are preferably inserted in appropriately provided recesses in the individual modules.

19. Dynamoelectric machine according to claim 1, characterized in that the entire heat exchanger is enclosed and sealed at its outer, initially open, edges by L-shaped (16) or U-shaped (16) sheet-metal sections with sealing strips (17) which are preferably attached in appropriately provided recesses.

20. Dynamoelectric machine according to claim, characterized in that the heat exchanger modules are held together through the provided U-shaped sheet-metal sections (16) and/or L-shaped sheet-metal sections (16) by a frame or using threaded rods (18) and self-locking nuts (21).

21. Dynamoelectric machine according to claim 1, characterized in that additional guides (39) for the cooling medium flow are provided in the housing of the cooler for the primary cooling circuit, and/or in the region of the cooling medium inlet and/or cooling medium outlet of the secondary cooling medium.
